(19) United States
(12) Patent Application Publication
(10) Pub. No.: US 2015/0079934 A1
(43) Pub. Date: Mar. 19, 2015

(54) POWER RECEIVER AND POWER TRANSFER AND RECEIVING SYSTEM

(71) Applicant: KABUSHIKI KAISHA TOSHIBA, Tokyo (JP)

(72) Inventors: Katsuyuki Kobayashi, Yokohama-Shi (JP); Takeo Hagiwara, Kawasaki-Shi (JP)

(73) Assignee: KABUSHIKI KAISHA TOSHIBA, Tokyo (JP)

(21) Appl. No.: 14/194,334

(22) Filed: Feb. 28, 2014

(30) Foreign Application Priority Data
Sep. 17, 2013 (JP) 2013-192234

(51) Int. Cl. H04W 12/06; H04M 1/725

(52) U.S. Cl. CPC H04W 12/06; H04M 1/72558
USPC 455/411; 455/26.1

(57) ABSTRACT

A power receiver capable of receiving power from a power transmitter and configured to communicate with the power transmitter, the power receiver has a communication module and a power receiver. The communication module is configured to transmit first device information, which is device information of the power receiver, to the power transmitter, receive second device information, which is device information of the power transmitter, transmitted from the power transmitter which has authenticated, based on the first device information, the power receiver as a target of power transfer, and then, transmit, to the power transmitter, an identification code corresponding to the second device information used to determine whether to establish a communication with the power transmitter. The power receiver is configured to receive power from the power transmitter which has authenticated the power receiver.

### CROSS REFERENCE TO RELATED APPLICATIONS

This application is based upon and claims the benefit of priority from the prior Japanese Patent Applications No. 2013-192234, filed on Sep. 17, 2013, the entire contents of which are incorporated herein by reference.

### FIELD

Embodiments described herein relate generally to a power receiver and a power transfer and receiving system.

### BACKGROUND

Smartphones are often powered by dock stations while transmitting music data to be played by the dock stations. This enables users to play the music data without fear of depleting batteries of the smartphones, or while recharging the batteries.

The most common method to establish communication between a smartphone and a dock station is manually inputting an identification code specific to the dock station, performed by the user. This ensures the security of the smartphone by reducing the risk of a malicious third party's device connecting to the smartphone without the awareness of the user. However, inputting an identification code would be inconvenient to the user.

### BRIEF DESCRIPTION OF THE DRAWINGS

FIG. 1 is a diagram showing an example of a power transfer and receiving system 100 according to the first embodiment.

FIG. 2 is a block diagram schematically showing configurations of a power receiver 1 and a power transmitter 2 of the first embodiment.

FIG. 3 is a sequence diagram showing an example of operations of the power receiver 1 and the power transmitter 2 shown in FIG. 2.

FIG. 4 is a block diagram schematically showing configurations of a power receiver 1 and a power transmitter 2′ according to the second embodiment.

FIG. 5 is a sequence diagram showing an example of operations of the power receiver 1 and the power transmitter 2′ shown in FIG. 4.

### DETAILED DESCRIPTION OF THE INVENTION

In general, according to one embodiment, a power receiver capable of receiving power from a power transmitter and configured to communicate with the power transmitter, the power receiver has a communication module and a power receiver. The communication module is configured to transmit first device information, which is device information of the power receiver, to the power transmitter, receive second device information, which is device information of the power transmitter, transmitted from the power transmitter which has authenticated, based on the first device information, the power receiver as a target of power transmission, and then, transmit, to the power transmitter, an identification code corresponding to the second device information used to determine whether to establish a communication with the power transmitter. The power receiver is configured to receive power from the power transmitter which has authenticated the power receiver.

Hereinafter, embodiments will be explained with reference to the drawings.

### First Embodiment

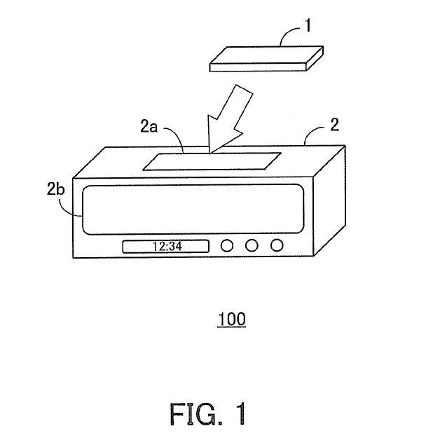

FIG. 1 is a diagram showing an example of a power transfer and receiving system 100 according to the first embodiment. The power transfer and receiving system 100 includes a power receiver 1 and a power transmitter 2. The power receiver 1 is a smartphone, for example, including a communication function of transmitting and receiving various data items such as music data items, and a power receiving function of receiving power from the power transmitter 2. The power transmitter 2 is a dock station, for example, including a playing function of playing such data as music data, a communication function of transmitting and receiving various data items, and a power transmitting function of transmitting power to the power receiver 1.

The power transmitter 2 transmits power wirelessly to the power receiver 1 placed on a power transmitting surface 2a while establishing communication with the power receiver 1 by, for example, Bluetooth (registered) pairing. Thereafter, music data is transmitted from the power receiver 1 to the power transmitter 2 to be played out of a speaker 2b of the power transmitter 2.

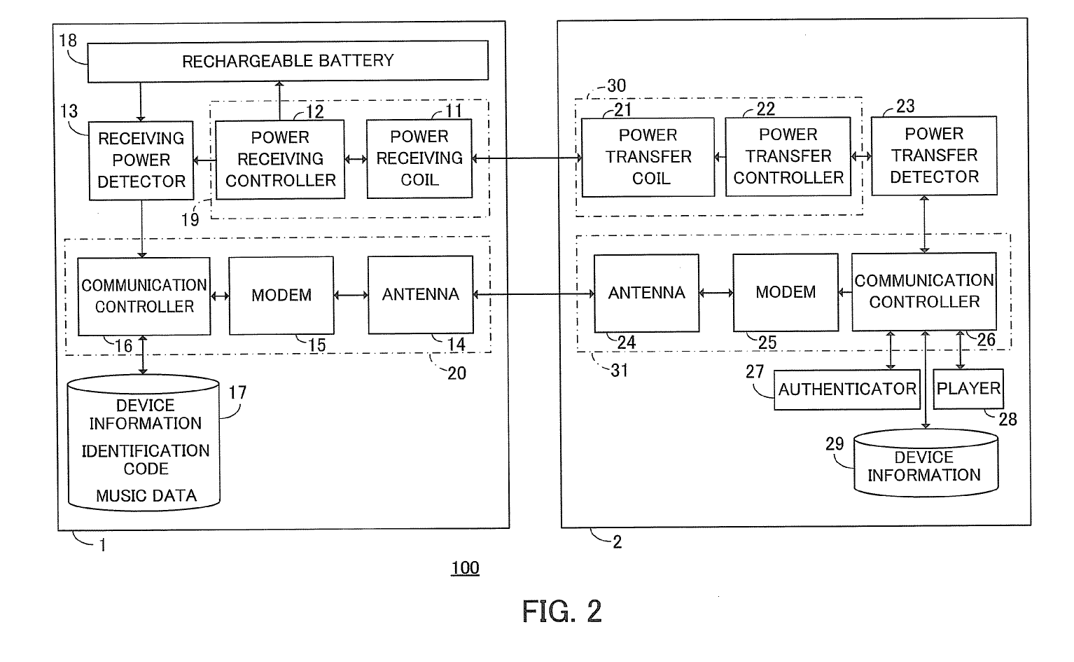

FIG. 2 is a block diagram schematically showing configurations of the power receiver 1 and the power transmitter 2 according to the first embodiment. The power receiver 1 includes a power receiving coil 11, a power receiving controller 12, a receiving power detector 13, an antenna 14, a modem 15, a communication controller 16, a storage 17, and a rechargeable battery 18.

The power receiving coil 11 is also called “secondary coil,” and receives, from the power transmitter 2, radio signals used to transmit power. The power receiving controller 12 receives power from the power receiving coil 11, and recharges the rechargeable battery 18. The power receiving coil 11 and the power receiving controller 12 constitute a power receiver 19.

The receiving power detector 13 detects power that should be received from the power transmitter 2 in consideration of the power received by the power receiving controller 12, the power required to operate respective modules in the power receiver 1, and the recharging state of the rechargeable battery 18. Power request information, which indicates the power to be received, is sent to the communication controller 16.

The antenna 14 transmits to and receives from the power transmitter 2 radio signals on which data is superimposed. When data is received, the modem 15 demodulates the radio signals received by the antenna 14 to obtain the data superimposed on the radio signals. When data is transmitted, the modem 15 modulates data to be transmitted to the power transmitter 2 and superimposes the modulated data on radio signals. The communication controller 16 processes the data obtained by the modem 15, generates data to be transmitted to the power transmitter 2, and supplies the generated data to the modem 15. The antenna 14, the modem 15, and the communication controller 16 constitute a communication module (first communication module) 20. The data transmitted to the power transmitter 2 includes the power request information described above, device information (first device information) of the power receiver 1, an identification code (such as a personal identification number (PIN)) needed for the pairing (connection setting) with the power transmitter 2, music data, etc.

The storage 17 stores the device information of the power receiver 1, the identification code needed for the pairing with the power transmitter 2, the music data, etc. The storage 17 may store a plurality of identification codes each for pairing with a different device.

The power transmitter 2 includes a power transfer coil 21, a power transfer controller 22, a power transfer detector 23, an antenna 24, a modem 25, a communication controller 26, an authenticator 27, a player 28, and a storage 29. The power transmitter 2 preferably operates by being powered externally.

The power transfer coil 21 is also called “primary coil,” and transmits radio signals for transmitting power to the power receiver 1. The power transfer controller 22 drives the power transfer coil 21 to transmit power from the power transfer coil 21 to the power receiving coil 11 wirelessly. The power transfer coil 21 and the power transfer controller 22 constitute a power transmitter 30.

The power transfer detector 23 detects power to be transmitted to the power receiver 1 based on the power request information received from the power receiver 1, and notifies the detected power to the power transfer controller 22. Furthermore, the power transfer detector 23 notifies, to the communication controller 26, transmitted power information that is actually transmitted from the power transfer coil 21 to the power receiver 1.

The antenna 24 receives the radio signals, on which the data is superimposed, from the power receiver 1. When data is received, the modem 25 demodulates the radio signals received from the antenna 24 to obtain the data superimposed on the radio signals. Furthermore, when data is transmitted, the modem 25 modulates data to be transmitted to the power receiver 1 and superimposes the modulated data on radio signals. The communication controller 26 processes the data obtained by the modem 25, generates data to be transmitted to the power receiver 1, and supplies the generated data to the modem 25. The antenna 24, the modem 25, and the communication controller 26 constitute a communication module (second communication module) 31. The data transmitted to the power receiver 1 includes transmitted power information, device information (second device information) of the power transmitter 2, pairing mode transition notification, etc.

The authenticator 27 determines whether power should be transmitted to the power receiver 1 or not based on the device information of the power receiver 1 sent from the power receiver 1. The player 28 plays music data sent from the power receiver 1, and is, for example, the speaker 2b shown in FIG. 1. The storage 29 stores such information as the device information of the power transmitter 2.

The wireless power transfer from the power transfer coil 21 to the power receiving coil 11 can be achieved based on such principles as electromagnetic induction and magnetic resonance. The communication between the communication module 20 of the power receiver 1 and the communication module 31 of the power transmitter 2 is established by such means as a wireless local area network (LAN).

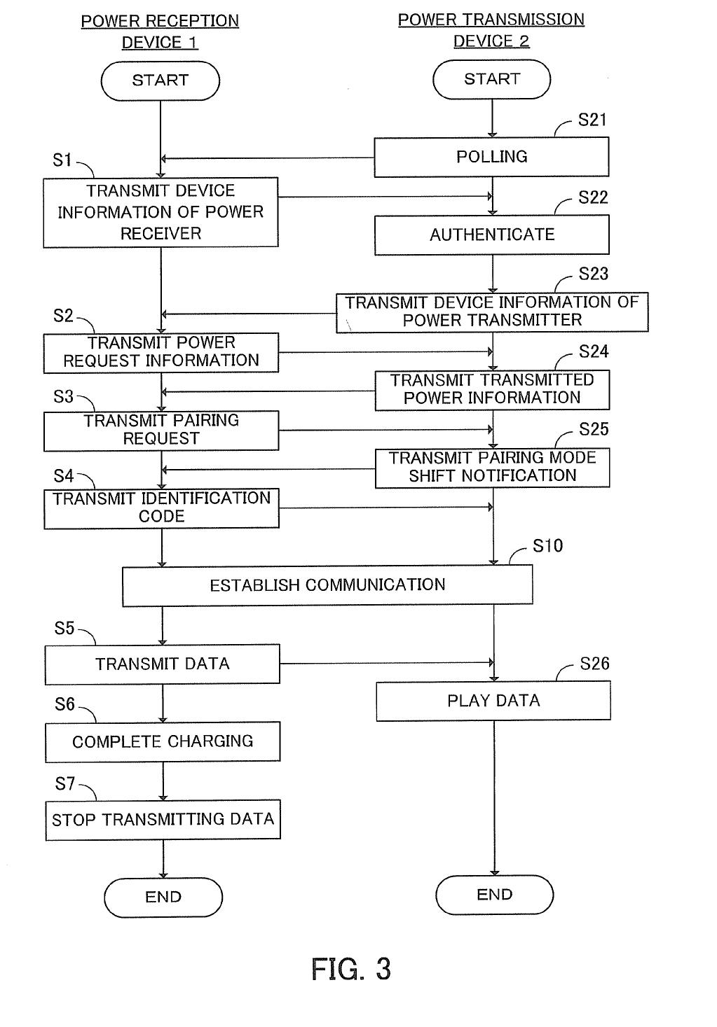

FIG. 3 is a sequence diagram showing an example of the operations of the power receiver 1 and the power transmitter 2 shown in FIG. 2. The communication module 31 of the power transmitter 2 always requests information on whether the power receiver 1 is placed on the power transmitting surface 2a. This is called “polling” (step S21). When the power receiver 1 is placed on the power transmitting surface 2a, the power transmitter 2 may transmit to the power receiver 1 a minimum power needed for the wireless power transfer authentication sequence.

In response to the request from the power transmitter 2, the power receiver 1 transmits its device information to the power transmitter 2 (step S1). More specifically, the communication module 20 reads the device information from the storage 17, modulates the read device information, and superimposes the modulated information on radio signals, and transmits the radio signals from the antenna 14 to the power transmitter 2.

The communication module 31 of the power transmitter 2 demodulates the radio signals to obtain the device information of the power receiver 1. Based on the device information obtained, the authenticator 27 determines whether power should be transmitted to the power receiver 1 or not (step S22). For example, if the device information obtained matches device information that has been registered in the power transmitter 2 to represent a device to which power should be transmitted, the authenticator 27 authenticates the power receiver 1 as a device to which power should be transmitted. The steps S1 and S22 are called “wireless power transfer authentication sequence.”

If the power receiver 1 is not a device to which power should be transmitted, the power transmitter 2 does not transmit power to the power receiver 1, and the following steps are not performed. If the power receiver 1 is authenticated as a device to which is power is transmitted, the communication module 31 transmits the device information of the power transmitter 2 to the power receiver 1 (step S23). More specifically, the communication module 31 reads the device information from the storage 29, modulates the read device information, superimposes the modulated information on radio signals, and transmits the radio signals from the antenna 24 to the power receiver 1. This initiates a full-scale power transfer.

The receiving power detector 13 of the power receiver 1 detects power needed by the power receiver 1, and generates power request information. Then, the communication module 20 transmits the power request information to the power transmitter 2 (step S2). The communication module 31 of the power transmitter 2 receives the power request information. Thereafter, the power transfer controller 22 drives the power transfer coil 21 to transmit the power requested by the power receiver 1. As a result, the power receiver 19 receives power from the power transmitter 2. Furthermore, the power transfer detector 23 generates transmitted power information indicating power actually transmitted. Subsequently, the communication module 31 transmits the transmitted power information to the power receiver 1 (step S24).

The above steps S2 and S24 are repeated between the power receiver 1 and the power transmitter 2, although this is not shown in the diagram. As a result, power is continuously transmitted from the power transmitter 2 to the power receiver 1. This is called “power transfer sequence.” The power transfer sequence is initiated by the user's action to place the power receiver 1 on the power transmitting surface 2a of the power transmitter 2.

On the premise that power is normally transmitted based on the power transfer sequence, the communication module 20 of the power receiver 1 transmits a pairing request (step S3) and searches for a target device in the pairing. A communication command, other than the power request information, for transmitting and receiving arbitrarily-determined (optional) information can also be used to send the pairing request.

When the communication module 31 of the power transmitter 2 receives the pairing request, the power transmitter 2 is shifted to a pairing mode, by which the power transmitter 2 can be searched by the device to be paired with. Then, the communication module 31 transmits, to the power receiver 1, a pairing mode transition notification indicating that the power transmitter 2 is shifted to the pairing mode (step S25).

Then, the power receiver 1 finds the power transmitter 2, which is shifted to the pairing mode, as a device to be paired with. Subsequently, in order to establish communication with the power transmitter 2, the communication module 20 transmits an identification code to the power transmitter 2 based on the device information of the power transmitter 2 transmitted in step S23 (step S4). More specifically, the communication module 20 retrieves an identification code corresponding to the device information of the power transmitter 2 from the storage 17, modulates the retrieved code, superimposes the modified code on radio signals, and transmits the radio signals from the antenna 14 to the power transmitter 2. The identification code is used to determine whether or not to establish communication with the power transmitter 2. The identification code is automatically transmitted by the power receiver 1 without the need for users operations or instructions such as inputting an identification code.

If the identification code matches the identification code preset in the power transmitter 2, the communication module 31 establishes communication between the power receiver 1 and the power transmitter 2 (step S10).

After the communication is established, the communication module 20 of the power receiver 1 transmits music data to the power transmitter 2 (step S5). The music data is received by the communication module 31 of the power transmitter 2, and played by the player 28 (step S26).

Incidentally, when the rechargeable battery 18 is recharged to a certain level by the power transfer sequence (step S6), the communication module 20 of the power receiver 1 may stop transmitting the music data to the power transmitter 2 (step S7). This notifies the user of the completion of the recharging.

As described above, in the first embodiment, the authentication for transmitting power is first performed. In authentication, the power receiver 1 receives the device information of the power transmitter 2 from the power transmitter 2. Then, the power receiver 1 automatically establishes communication with the power transmitter 2 using the device information of the power transmitter 2. This can omit user's botheration, and it is possible to establish communication between the power receiver 1 such as a smartphone and the power transmitter 2 such as a dock station easily. Furthermore, since the authentication for power transmitting is initiated by the user's action, the risk of establishing communication against the user's will is very low. Thus, the authentication can be performed safely.

### Second Embodiment

In the first embodiment, the power receiver 1 and the power transmitter 2 communicate with each other bi-directionally. However, in the second embodiment, the communication is established in one direction, from the power receiver 1 to the power transmitter 2. Hereinafter, the differences between the first embodiment and the second embodiment will be mainly described.

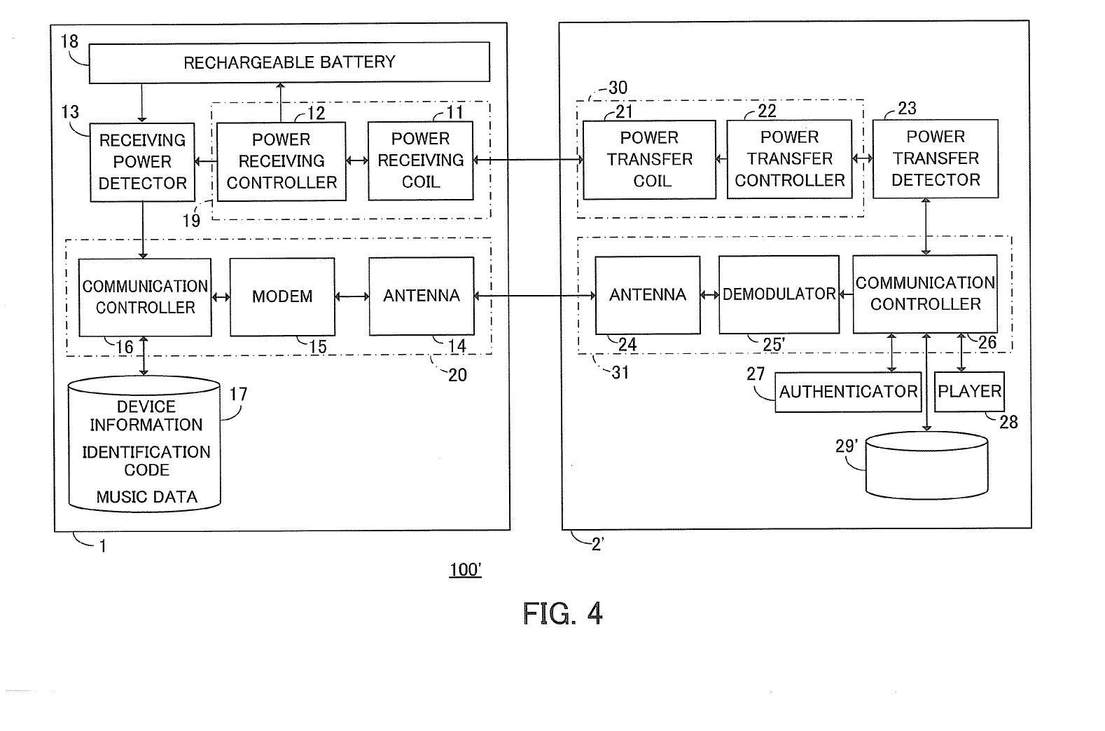

FIG. 4 is a block diagram schematically showing configurations of a power receiver 1 and a power transmitter 2′ according to the second embodiment. The power transmitter 2′, which receives data but does not transmit data, includes a demodulator 25′ instead of a modem. A storage 29′ of the power transmitter 2′ may not store device information of the power transmitter 2′. Furthermore, a storage 17 of the power receiver 1 stores a predetermined one identification code, which is not dependent on a device to which the power receiver 1 is to be connected. The other features of the respective elements are substantially the same as those shown in FIG. 2.

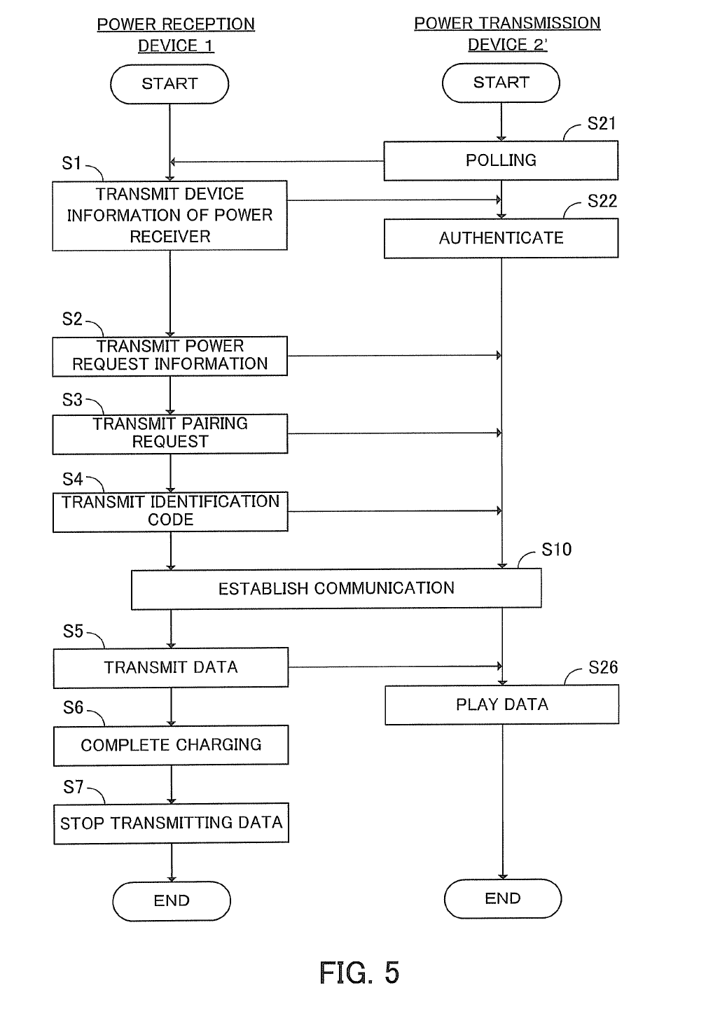

FIG. 5 is a sequence diagram showing an example of operations of the power receiver 1 and the power transmitter 2′ shown in FIG. 4. A main difference between FIG. 5 and FIG. 3 is that data is not transmitted from the power transmitter 2′ to the power receiver 1. For example, if the power transmitter 2′ is allowed to transmit power in the wireless power transfer authentication sequence, the power transmitter 2′ does not transmit its device information to the power receiver 1. Furthermore, in the power transfer sequence, the power transmitter 2′ does not transmit the transmitted power information to the power receiver 1.

Since the power receiver 1 does not receive the device information of the power transmitter 2′, the power receiver 1 performs pairing in the following manner. First, the power receiver 1 grasps the authentication by the power transmitter 2′ by receiving power from the power transmitter 2′. Assuming that the authentication is performed, in other words, while the power receiver 19 is receiving power from the power transmitter 2′, the power receiver 1 transmits a pairing request to the power transmitter 2′ (step S3). This shifts the power transmitter 2′ to a pairing mode, by which the power transmitter 2′ can be searched for by a device to be paired with. Assuming that the power transmitter 2′ is shifted to the pairing mode, the power receiver 1 transmits a predetermined identification code to the power transmitter 2′ (step S4).

If this identification code matches the identification code preset in the power transmitter 2′, the communication between the power receiver 1 and the power transmitter 2′ is established (step S10). The other operations are substantially the same as those illustrated in FIG. 3.

As described above, a predetermined identification code is transmitted to the power transmitter 2′ in the second embodiment. Accordingly, even if the power transmitter 2′ does not have a data transmitting function, communication between the power receiver 1 and the power transmitter 2′ can be established easily and safely.

Although FIGS. 2 to 4 show an example in which power transfer/receiving and data transfer/receiving are performed via different paths, they can be performed via a single path. For example, data can be superimposed on radio signals for transmitting power, and the radio signals can be transmitted and received between coils.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A power receiver capable of receiving power from a power transmitter and configured to communicate with the power transmitter, the power receiver comprising:
a communication module configured to
transmit first device information, which is device information of the power receiver, to the power transmitter,
receive second device information, which is device information of the power transmitter, transmitted from the power transmitter which has authenticated, based on the first device information, the power receiver as a target of power transfer, and then,
transmit, to the power transmitter, an identification code corresponding to the second device information used to determine whether to establish a communication with the power transmitter; and
a power receiver configured to receive power from the power transmitter which has authenticated the power receiver.

2. The device of claim 1, wherein the communication module is configured to transmit the identification code corresponding to the second device information without user's instruction.

3. The device of claim 1, wherein the communication module is configured to
transmit a pairing request to the power transmitter,
receive a pairing mode transition notification from the power transmitter whose mode has shifted to a pairing mode according to the paring request, and then,
transmit the identification code corresponding to the second device information to the power transmitter.

4. The device of claim 1, further comprising a storage in which the identification code is stored associated with the second device information.

5. The device of claim 1, wherein the communication module is configured to transmit data to be played by the power transmitter after the communication with the power transmitter has established.

6. The device of claim 1, further comprising a rechargeable battery charged by the power the power receiver receives.

7. The device of claim 6, wherein the communication module is configured to transmit data to be played by the power transmitter after the communication with the transmitter has established, and
when the rechargeable battery is charged with a first level, the communication module stops transmitting the data.

8. A power receiver configured to communicate with a power transmitter, the power receiver comprising:
a communication module configured to transmit first device information, which is device information of the power receiver, to the power transmitter; and
a power receiver configured to receive power from the power transmitter which has authenticated the power receiver based on the first device information,
wherein the communication module is configured to transmit, to the power transmitter, a first identification code used to determinate whether to establish a communication with the power transmitter while the power receiver is receiving the power from the power transmitter.

9. The device of claim 8, wherein the communication module is configured to transmit the first identification code without user's instruction.

10. The device of claim 8, wherein the communication module is configured to
transmit a paring request to the power transmitter, and then,
transmit the first identification code to the power transmitter.

11. The device of claim 8, further comprising a storage in which the first identification code is stored.

12. The device of claim 8, wherein the communication module is configured to transmit data to be played by the power transmitter after the communication with the transmitter has established.

13. The device of claim 8, further comprising a rechargeable battery charged by the power the power receiver receives.

14. The device of claim 13, wherein the communication module is configured to transmit data to be played by the power transmitter after the communication with the transmitter has established, and
when the rechargeable battery is charged with a first level, the communication module stops transmitting the data.

15. A power transfer and receiving system comprising:
a power transmitter configured to transmit power; and
a power receiver capable of receiving power from the power transmitter and configured to communicate with the power transmitter,
wherein the power receiver comprises:
a first communication module configured to
transmit first device information, which is device information of the power receiver, to the power transmitter,
receive second device information, which is device information of the power transmitter, transmitted from the power transmitter which has authenticated, based on the first device information, the power receiver as a target of power transfer, and then,
transmit, to the power transmitter, an identification code corresponding to the second device information used to determine whether to establish a communication with the power transmitter; and
a power receiver configured to receive power from the power transmitter which has authenticated the power receiver,
wherein the power transmitter comprises:
an authenticator configured to authenticate the power receiver as a target of power transfer based on the first, device information;
a second communication module configured to transmit the second device information to the authenticated power receiver, and to establish the communication with the power receiving module based on the identification code; and
a power transmitter configured to transmit the power to the authenticated power receiver.

16. The system of claim 15, wherein the first communication module is configured to transmit the identification code corresponding to the second device information without user's instruction.

17. The system of claim 15, wherein the first communication module is configured to
transmit a pairing request to the power transmitter,
receive a pairing mode transition notification from the power transmitter whose mode has shifted to a pairing mode according to the paring request, and then,
transmit the identification code corresponding to the second device information to the power transmitter.

18. The system of claim 15, wherein the power receiver further comprises a storage in which the identification code is stored associated with the second device information.

19. The system of claim 15, wherein the first communication module is configured to transmit data to be played by the power transmitter after the communication with the power transmitter has established.

20. The system of claim 19, wherein the power transmitter further comprises a player configured to play the data.
